(19) United States
(12) Patent Application Publication
(10) Pub. No.: US 2011/0288871 A1
(43) Pub. Date: Nov. 24, 2011

(54) INFORMATION PRESENTATION SYSTEM

(75) Inventor: Kazuhisa SUZUKI, Kariya-city (JP)

(73) Assignee: DENSO CORPORATION, Kariya-city (JP)

(21) Appl. No.: 13/109,323

(22) Filed: May 17, 2011

(30) Foreign Application Priority Data
May 18, 2010 (JP) 2010-114453

(51) Int. Cl. G10L 15/00; G10L 11/00

(52) U.S. Cl. 704/275; 704/251; 704/E15.001; 704/E11.001

(57) ABSTRACT

In an in-vehicle navigation apparatus, an in-vehicle BT communications device receives a speech recognition result via a BT communications link from a cellular phone. Based on the received speech recognition result, an in-vehicle control circuit outputs a talk-back sound about the speech recognition result via an in-vehicle sound output device.

### CROSS REFERENCE TO RELATED APPLICATION

The present application is based on and incorporates herein by reference Japanese Patent Application No. 2010-114453 filed on May 18, 2010.

### FIELD OF THE INVENTION

The present invention relates to an information presentation system.

### BACKGROUND OF THE INVENTION

[Patent document 1] JP-2005-91611 A

There is conventionally known a speech recognition technology to recognize a speech uttered by a user. The speech recognition technology has been used for operating various instruments in cases where a switch manipulation for the instruments is difficult to perform. For example, the switch manipulation during driving a vehicle is difficult to perform; thus, the speech recognition technology has been used for operating an in-vehicle navigation apparatus.

Furthermore, in recent years, the speech recognition technology has been also used for various instruments such as a portable terminal as well as the in-vehicle navigation apparatus. In addition, in recent years there is also proposed a technology which performs a speech recognition process in a server having a high throughput, as recited in Patent document 1, for example.

Generally, a series of operations in a speech recognition take place as follows: a guide speech is outputted to prompt a user's speech input; after the speech input is made via a sound input section, based on the data of the speech command indicated through the speech input, a speech recognition is executed using a dictionary for speech recognition; and the recognition result of the speech recognition is displayed while the talk-back speech based on the recognition result is outputted.

In contrast, in the speech recognition system performing a speech recognition in a server, another different series of operations take place. For example, in the system where a portable terminal receives a speech input from a user and a server performs a speech recognition, there are some cases where although displaying the speech recognition result itself or a window of contents corresponding to the speech recognition result, the portable terminal does not output a talk-back speech corresponding to the speech recognition result.

Such a portable terminal which does not output a talk-back speech corresponding to the speech recognition result may be brought into a vehicle by a driver; then, the driver may perform an action for speech recognition during driving the vehicle. In such a case, the driver need look at a display window of the portable terminal during driving of the vehicle to confirm the speech recognition result. Gazing at the display window of the portable terminal during driving a vehicle is not desirable in view of safe driving. Therefore, if a driver brings the portable terminal, which does not output the talk-back speech about the speech recognition result, into a vehicle and then performs an action for speech recognition, it is difficult for the driver to confirm the speech recognition result, reducing a convenience for the driver.

### SUMMARY OF THE INVENTION

The present invention is made in view of the above problem. It is an object of the present invention to provide an information presentation system which enables a driver under driving a vehicle to easily confirm information corresponding to display information according to a function of a portable terminal.

To achieve the above object according to an embodiment of the present invention, an information presentation system including an in-vehicle apparatus in a vehicle and a portable terminal that performs data communications with the in-vehicle apparatus is provided as follows. The portable terminal performs a display based on display related information according to a function of the portable terminal itself. The in-vehicle apparatus includes a sound output device which outputs a sound, a data acquisition device which acquires the display related information from the portable terminal through the data communications, and an output control section configured to cause the sound output device to output a sound according to the function of the portable terminal, based on the display related information according to the function of the portable terminal acquired by the data acquisition device.

Under such a configuration, the display information which should be displayed according to a function of the portable terminal is outputted as a speech to the driver from the in-vehicle apparatus. Even if the driver is during driving of the vehicle, the driver is thus enabled to easily confirm the information corresponding to the display information that is displayed according to the function of the portable terminal.

### BRIEF DESCRIPTION OF THE DRAWINGS

The above and other objects, features, and advantages of the present invention will become more apparent from the following detailed description made with reference to the accompanying drawings. In the drawings:

FIG. 1 is a block diagram illustrating a configuration of an information presentation system according to an embodiment of the present invention;

FIG. 2 is a block diagram illustrating a configuration of a cellular phone according to the embodiment;

FIG. 3 is a block diagram illustrating a configuration of a speech recognition server according to the embodiment;

FIG. 4 is a block diagram illustrating a configuration of an in-vehicle navigation apparatus according to the embodiment;

FIG. 5 is a flowchart diagram illustrating a process pertinent to an output of a talk-back speech by the in-vehicle navigation apparatus acting as proxy for the cellular phone; and

FIG. 6 is a flowchart diagram illustrating an arbitration process.

### DETAILED DESCRIPTION OF THE PREFERRED EMBODIMENTS

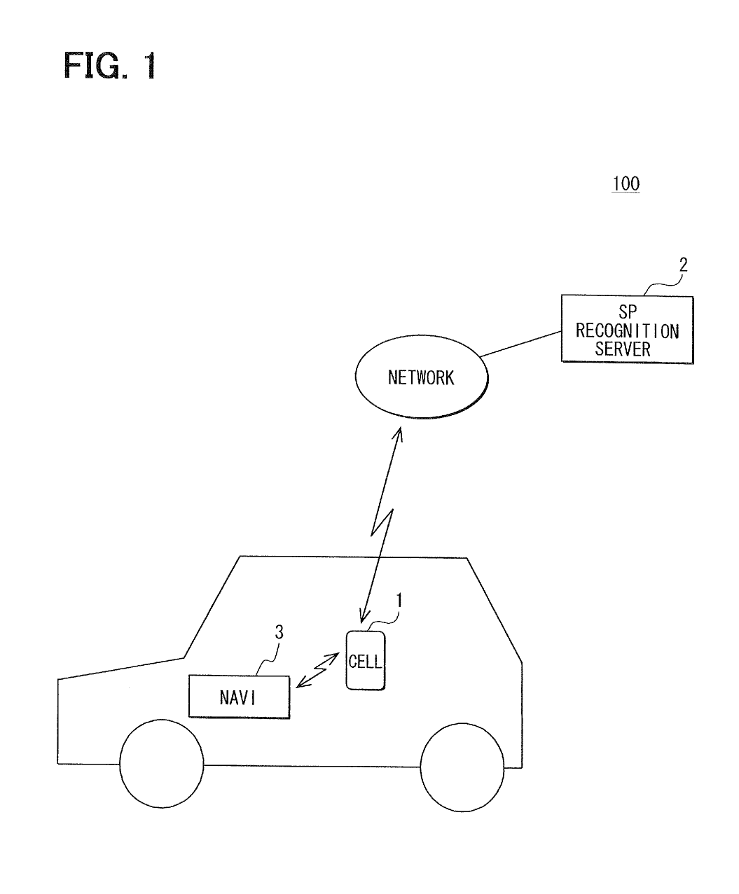

An embodiment of the present invention is explained with reference to drawings. FIG. 1 is a block diagram illustrating an overall configuration of an information presentation system 100 according to an embodiment of the present invention. As illustrated in FIG. 1, the information presentation system 100 includes a cellular phone 1, a speech recognition server 2, and an in-vehicle navigation apparatus 3 in a vehicle.

The cellular phone 1 has a speech recognition function which enables operations of a variety of applications by speech input, as well as a telephone function, a mail function, etc. contained by a general cellular phone. The cellular phone 1 may be referred to as a portable terminal.

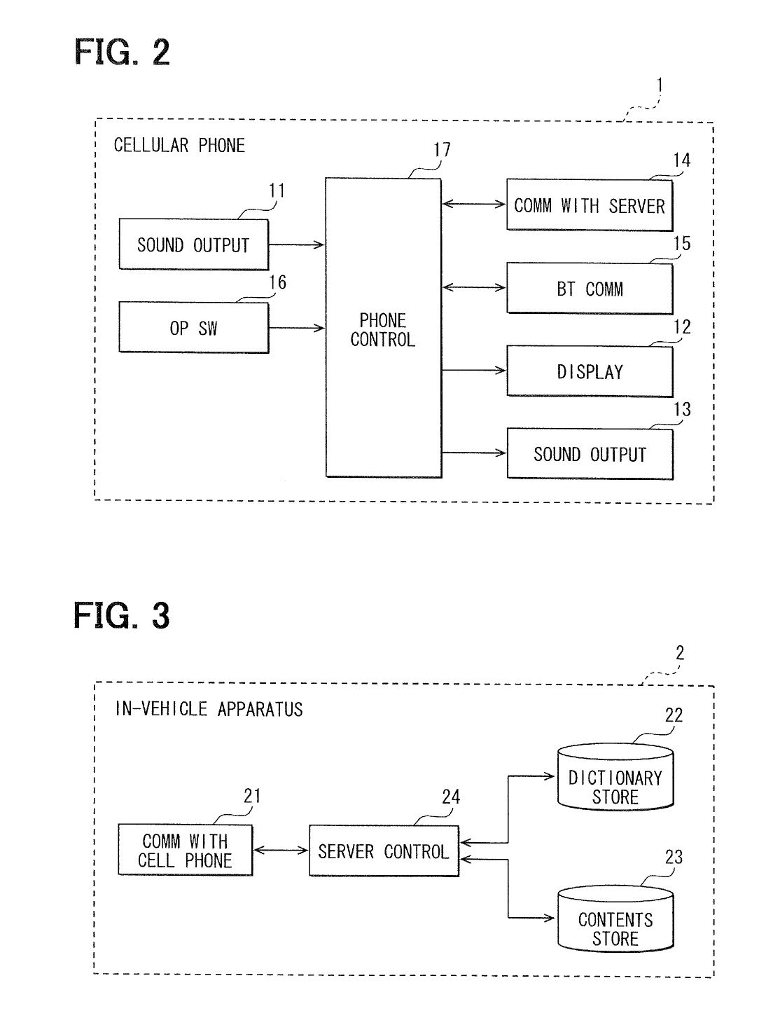

The following explains an outline configuration of the cellular phone 1 with reference to FIG. 2. It is noted that the following explanation is made mainly with respect to necessary portions or functions of the cellular phone among the functions of a general cellular phone. FIG. 2 is a block diagram illustrating a configuration of the cellular phone 1. As illustrated in FIG. 2, the cellular phone 1 includes the following: a sound input device 11, a display device 12, a sound output device 13, a communications device 14, a Bluetooth (registered trademark) communications device 15, an operation switch group 16, and a phone control circuit 17.

The sound input device 11 collects user's utterance speech (speech command to the cellular phone 1), transforms the collected speech into a digital sound signal (i.e., speech data), and outputs the sound signal to the phone control circuit 17. In detail, the sound input device 11 transforms the speech command, which corresponds to an operation of each application of the cellular phone 1, into the sound signal and outputs the sound signal. In addition, the sound input device 11 can be achieved using a small digital microphone, for example.

The display device 12 displays (i) a window according to each application of the cellular phone 1 and (ii) contents serving as a target of each application. The display device 12 enables a color display and includes a liquid crystal display, an organic electroluminescence display, a plasma display, or the like. In addition, the sound output device 13 includes a speaker and outputs a speech of a call partner, various guide sounds or speeches, etc based on instructions of the phone control circuit 17.

The guide speeches outputted from the sound output device 13 include a guide speech based on guide data for a facility obtained by reading two-dimensional bar code or downloading via a network. In addition, when the cellular phone 1 has a route guide function, a guide speech for navigation is included.

The communications device 14 communicates with the speech recognition server 2 via a network such as a cellular phone network. The communications device 14 transmits, to the speech recognition server 2, speech data transmitted from the phone control circuit 17 according to an instruction of the phone control circuit 17, and receives, from the speech recognition server 2, a speech recognition result that is obtained by executing a speech recognition based on the speech data in the speech recognition server 2. In addition, the speech recognition result received from the speech recognition server 2 is inputted into the phone control circuit 17.

The Bluetooth (referred to as BT) communications device 15 includes a BT antenna. The BT communications device 15 transmits a signal over electric waves of 2.4 GHz bandwidth to the in-vehicle navigation apparatus 3 via the BT antenna, and receives a signal over electric waves of 2.4 GHz bandwidth from the in-vehicle navigation apparatus 3 via the BT antenna. In detail the BT communications device 15 transmits, to the in-vehicle navigation apparatus 3, the speech recognition result received from the speech recognition server 2.

For example, the operation switch group 16 includes a mechanical switch or touch-sensitive switch which is integrated with the display device 12. According to a switch manipulation an operation instruction for each of various functions is issued to the phone control circuit 17.

The phone control circuit 17 is a known computer to contain a CPU, ROM, RAM, I/O, and bus line connecting the foregoing components (none shown). The phone control circuit 17 executes various processes based on a variety of information inputted from the sound input device 11, the communications device 14, the BT communications device 15, and the operation switch group 16.

For example, when the speech data is inputted from the sound input device 11, the phone control circuit 17 transmits the speech data to the communications device 14 and causes the communications device 14 to transmit the speech data to the speech recognition server 2 via the network.

When receiving via the operation switch group 16 an input for selecting a BT instrument serving as a pairing partner with the cellular phone 1, the phone control circuit 17 executes a pairing process so as to enable BT communications with the BT instrument, which is selected by the operation switch group 16, via the BT communications device 15. Such a pairing process may be performed in a manner similar to that of a known pairing process performed between BT instruments. The following explanation will be made on the premise that in the present embodiment, the cellular phone 1 and the in-vehicle navigation apparatus 3 are paired with each other.

Furthermore, when the phone control circuit 17 receives the speech recognition result obtained by the speech recognition server 2 via the communications device 14 under the state where the pairing is established between the cellular phone 1 and the in-vehicle navigation apparatus 3, the phone control circuit 17 transmits the speech recognition result obtained by the speech recognition server 2 to the BT communications device 15 and causes the BT communications device 15 to transmit the speech recognition result to the in-vehicle navigation apparatus 3.

In contrast, when the phone control circuit 17 receives the speech recognition result obtained by the speech recognition server 2 via the communications device 14 under the state where the pairing is not established between the cellular phone 1 and the in-vehicle navigation apparatus 3, the phone control circuit 17 transmits the speech recognition result obtained by the speech recognition server 2 to the display device 12 of the cellular phone 1 and causes the display device 12 to display information indicating the speech recognition result. It is noted that it is a premise that the cellular phone 1 in the present embodiment does not have a function, which transmits the speech recognition result to the sound output device 13 so as to perform an output of a speech indicating the speech recognition result (i.e. a talk-back speech corresponding to the speech recognition result).

Returning to FIG. 1, the speech recognition server 2 executes a speech recognition based on the above-mentioned sound data transmitted from the cellular phone 1, and returns the speech recognition result to the cellular phone 1. It is noted that the speech recognition server 2 may include one server or more than one server.

The following explains an outline configuration of the speech recognition server 2 with reference to FIG. 3. FIG. 3 is a block diagram illustrating a configuration of the speech recognition server 2. As illustrated in FIG. 3, the speech recognition server 2 includes a communications device 21, a dictionary storage device 22, a contents data storage device 23, and a server control circuit 24.

The communications device 21 communicates with the cellular phone 1 via the network such as the cellular phone network. In detail, the communications device 21 receives the speech data transmitted from the cellular phone 1, and inputs the speech data into the server control circuit 24. In addition, the communications device 21 transmits the speech recognition result sent from the server control circuit 24 to the cellular phone 1 according to an instruction of the server control circuit 24.

The dictionary storage device 22 stores a dictionary for speech recognition. Such a dictionary stored in the dictionary storage device 22 may use a well-known dictionary used for speech recognition. For example, such a dictionary may associate a word with phoneme(s) expressing a pronunciation of the word or a phonetic symbol.

In addition, the contents data storage device 23 stores data of contents as a target of each application used in the cellular phone 1. Such contents include data of an image, a sound, a character, and a figure.

The server control circuit 24 is a known computer to contain a CPU, ROM, RAM, I/O, and bus line connecting the foregoing components (none shown). The server control circuit 24 executes various processes based on a variety of information inputted from the communications device 21, the dictionary storage device 22, and the contents data storage device 23.

When receiving the speech data via the communications device 21, the server control circuit 24 extracts a sound feature quantity from the sound signal of the speech data to generate feature quantity data. The technique to extract a sound feature quantity from the sound signal so as to generate feature quantity data uses a known one such as an LPC analyzing technique. Then, based on the feature quantity data, the server control circuit 24 executes a speech recognition using the dictionary for speech recognition stored in the dictionary storage device 22.

The above speech recognition may use a well-known technique such as the Hidden Markov Model etc. Further, the above dictionary stored in the dictionary storage device 22 may use a well-known dictionary used for speech recognition. For example such a dictionary may associate a word with phoneme(s) expressing a pronunciation of the word or a phonetic symbol.

In addition, the server control circuit 24 transmits the speech recognition result from the speech recognition to the communications device 21, replying to the cellular phone 1 that serves as a speech data transmission origin. The server control circuit 24 outputs, as a speech recognition result, text data of characters resulting from the speech recognition, for instance, replying the text data to the cellular phone 1. In addition, the server control circuit 24 may attach the text data of characters resulting from the speech recognition with a tag of XML (Extensible Markup Language), for instance; thereby, the in-vehicle navigation apparatus 3 may read out the text data.

In addition, not only the text data but also the sound signal may be outputted; such a sound signal may be prepared by applying the text data to the speech synthesis. Thus, the sound signal as well as the text data may be replied to the cellular phone 1 as the speech recognition result. Furthermore, the server control circuit 24 may reply the phoneme data resulting from the speech recognition to the cellular phone 1. It is noted that the text data and phoneme data serving as a speech recognition result may be referred to as display related data. The speech recognition result may be referred to as information according to a function of the cellular phone or portable terminal.

Furthermore, according to the command indicated by the text data resulting from the speech recognition based on the speech data serving as the speech command, the server control circuit 24 reads out from the contents data storage device 23 the contents data used in the application corresponding to the speech command, and transmits it to the communications device 21, thereby transmitting the contents data to the cellular phone 1 serving as a speech data transmission origin.

Further, the cellular phone 1 executes a process according to the speech recognition result replied from the speech recognition server 2, starting an operation of the application according to the above-mentioned speech command. Furthermore, when the contents need to be displayed in association with the operation of the application, the cellular phone 1 displays the contents based on the above-mentioned contents data transmitted from the speech recognition server 2.

As explained above, in the present embodiment, the server control circuit 24 of the speech recognition server 2 extracts a sound feature quantity based on the speech data and generates the feature quantity data. Without need be limited to the above, for example, the phone control circuit 17 of the cellular phone 1 may extract a sound feature quantity based on the speech data inputted via the sound input device 11 of the cellular phone 1 itself and generates the feature quantity data. In such a case, the communications device 14 of the cellular phone 1 may transmit the feature quantity data generated by the phone control circuit 17 to the server control circuit 24 of the speech recognition server 2 via the communications devices 21, 14. Based on the feature quantity data, the server control circuit 24 of the speech recognition server 2 may execute a speech recognition.

Returning to FIG. 1, as explained above, the in-vehicle navigation apparatus 3 is mounted in a vehicle such as an automobile. The in-vehicle navigation apparatus 3 may be referred to as an in-vehicle apparatus. The in-vehicle navigation apparatus 3 has not only a navigation function to perform a route guide but also a function of performing wireless communications with the cellular phone 1. Hereinafter, the vehicle which is provided with the in-vehicle navigation apparatus 3 is referred to as a subject vehicle.

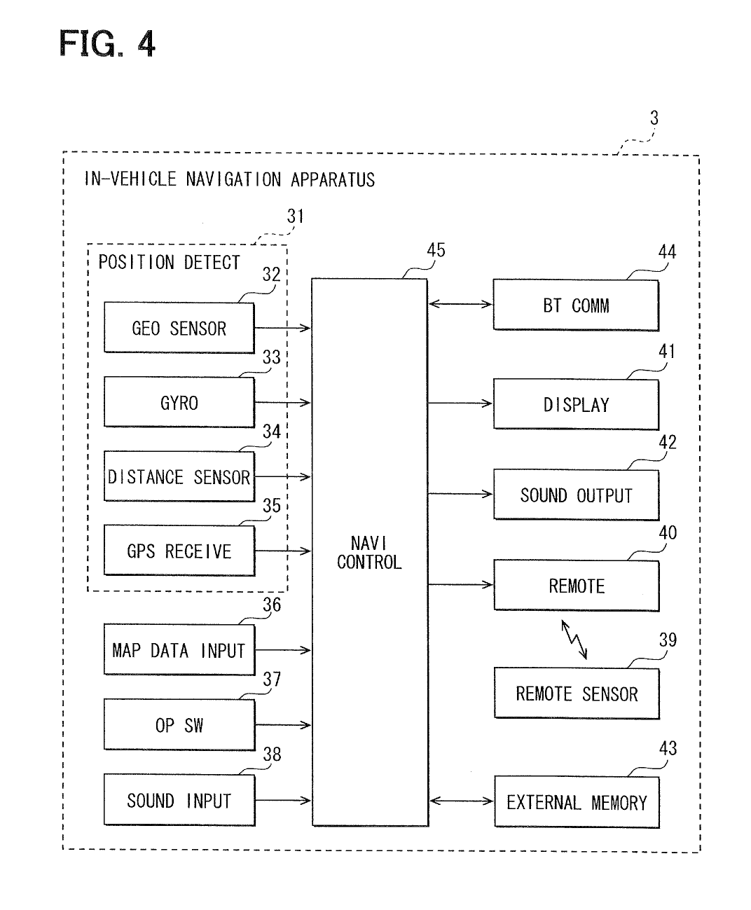

The following explains an outline configuration of the in-vehicle navigation apparatus 3 with reference to FIG. 4. FIG. 4 is a block diagram illustrating a configuration of the in-vehicle navigation apparatus. As illustrated in FIG. 4, the in-vehicle navigation apparatus 3 includes a position detection device 31, a map data input device 36, an operation switch group 37, an in-vehicle sound input device 38, a remote control 39, a remote control sensor 40, a display device 41, an in-vehicle sound output device 42, an external memory 43, an in-vehicle Bluetooth (BT) communications device 44, and a navigation control circuit 45 (also referred to as an in-vehicle control circuit 45).

The position detection device 31 includes an acceleration sensor 32 which detects an acceleration of the subject vehicle, a gyroscope 33 which detects an angular velocity around a perpendicular direction of the subject vehicle, a wheel velocity sensor 34 which detects a velocity of, the subject vehicle from a rotation speed of each rotating wheel and a GPS receiver 35 for GPS (Global Positioning System) which detects a present position of the subject vehicle based on electric waves from artificial satellites. The individual sensors or the like 32 to 35 have types of detection errors different from each other; therefore, they are used to complement each other. In addition, part of the sensors or the like may be used depending on the required detection accuracy or each sensor's detection accuracy. Further, another sensor or the like such as a vehicle velocity sensor detecting a velocity from the rotation speed of each rotating wheel may be used.

The map data input device 36 is used for inputting the various data containing map data, data for map matching for improving positioning accuracy, and landmark data from a storage media (not shown) inserted into the map data input device 36. The map data include road data having node data and link data for indicating roads. Nodes are points at which roads cross, branch, or join; links are segments between nodes. A road is constituted by connecting links. Link data relative to each link include a unique number (link ID) for specifying the link, a link length for indicating the length of the link, start and end node coordinates (latitudes and longitudes), a road name, a road class, a road width, the number of lanes, presence/absence of dedicated lanes for right/left turn and the number thereof, and a speed limit.

Node data relative to each node include a unique number (node ID) for specifying the node, node coordinates, a node name, connection link IDs for indicating links connected to the node, and an intersection class.

Moreover, the above storage media includes data on classes, names, and addresses of various facilities, which are used to designate destinations in route retrieval, etc. The above storage media may be a CD-ROM, DVD-ROM, memory card, HDD, or the like.

The operation switch group 37 is, for instance, a mechanical switch or touch switch integrated with the display device 41 and demands executions of various functions to the navigation control circuit 45 based on switch operations. The executed functions include, for example, a map scale change, a menu display selection, a destination designation a route retrieval, a route guide start, a present position correction a display window change, and a volume control.

The in-vehicle sound input device 38 collects a user's speech (speech command to the in-vehicle navigation apparatus 3), transforms the collected speech into the digital sound signal (speech data), outputting it to the navigation control circuit 45. The sound input device 38 includes a digital microphone.

The remote control 39 includes several operation switches (not shown). Switch manipulation to the remote control 39 enables an input of the various instruction signals to the navigation control circuit 45 via the remote sensor 40. Thus, the remote control 39 can cause the navigation control circuit 45 to execute functions like the operation switch group 37.

The display device 41 displays maps or destination selection windows for guiding the travel of the subject vehicle, and is able to display images in full colors using such as a liquid crystal display, an organic electroluminescence display, or a plasma display. In addition, the in-vehicle sound output device 42 includes a speaker and outputs a sound of a call partner, various guide sounds for navigation, etc. based on instructions of the navigation control circuit 45.

The external memory 43 is a rewritable memory with a large data volume such as a hard disk drive (HDD). The external memory 43 stores data, which need to be inerasable even if power supply is turned off, or is used for copying frequently used data from the map, data input device 36. In addition, the external memory 10 may be removable memory.

The in-vehicle BT communications device 44 has a BT antenna and transmits a signal over electric waves of 2.4 GHz bandwidth to the cellular phone 1 via the BT antenna, and receives a signal over electric waves of 2.4 GHz bandwidth from the cellular phone 1 via the BT antenna. In addition, the BT communications device 44 is connected with the navigation control circuit 45, and outputs the speech recognition result received from the cellular phone 1 via the in-vehicle BT antenna to the navigation control circuit 45. The in-vehicle BT communications device 44 may be referred to as a data acquisition device.

In addition a communications area of a signal transmitted from the in-vehicle BT communications device 44 is limited to a vehicle compartment of the subject vehicle. It may be designed that the BT communications between the in-vehicle navigation apparatus 3 and the cellular phone 1 are limited to inside of the vehicle compartment.

The navigation control circuit 45 is a known computer to contain a CPU, ROM, RAM, I/O, and bus line connecting the foregoing components (none shown). The navigation control circuit 45 executes a process as a navigation function, a process of wirelessly communicating with the cellular phone 1, and a process related with a speech output of a speech recognition result based on a variety of information inputted from the position detection device 31, the map data input device 36, the operation switch group 37, the in-vehicle sound input device 38, the remote control sensor 40, the external memory 43, and the in-vehicle BT communications device 44. The process as the navigation function includes a map scale change process, a menu display selection process, a destination designation process, a route retrieval process, a route guide starting process, a present position correction process, a display window change process and a volume control process. The process related with a speech output resulting from the speech recognition includes a talk-back speech output process and a mute process, and is acted by the navigation control circuit 45 of the in-vehicle navigation apparatus 3 as proxy for the cellular phone 1.

For example, the navigation control circuit 45 executes the above-mentioned pairing process to enable the BT communications with the cellular phone 1 via the in-vehicle BT communications device 44. In addition, when receiving the speech recognition result from the cellular phone 1, which is paired as a communications partner, via the in-vehicle BT communications device 44, the navigation control circuit 45 performs a talk-back speech output process to cause the in-vehicle sound output device 42 to output the speech indicating the speech recognition result. Herein, the navigation control circuit 45 may be referred to as an output control section or means.

In the talk-back speech output process, the navigation control circuit 45 operates as follows. When the speech recognition result is text data, a known speech synthesis is executed based on the text data, generating a sound signal indicating the speech recognition result; the generated sound signal is transmitted to the in-vehicle sound output device 42, enabling an output of the talk-back speech. In addition when the speech recognition result is text data assigned with a tag of XML, the text data is read out according to the tag, enabling an output of the talk-back speech via the in-vehicle sound output section 42.

Furthermore, when the speech recognition result includes not only the text data but also a sound signal, the included sound signal is transmitted to the in-vehicle sound output device 42, enabling an output of the talk-back speech. That is, when the speech recognition server 2 generates a sound signal indicating a speech recognition result, and outputs as the speech recognition result the sound signal at least, the in-vehicle sound output device 42 may be caused to output a speech according to the sound signal indicating the speech recognition result, enabling an output of, as a talk-back speech the speech indicating the speech recognition result.

In addition, when the speech recognition result is phoneme data, a known speech synthesis is executed based on the phoneme data, generating a sound signal indicating the speech recognition result; the generated sound signal is transmitted to the in-vehicle sound output device 42, enabling an output of the talk-back speech.

The navigation control circuit 45 also executes, in addition to the talk-back speech output process, a vehicle-side usual sound output process to output a sound according to the function of the in-vehicle navigation apparatus 3 such as a guide speech or sound for navigation via the in-vehicle sound output device 42. Herein, the vehicle-side usual sound output may be referred to as an in-vehicle apparatus-side usual sound output or a navigation apparatus-side usual sound output. Furthermore, the navigation control circuit 45 executes a mute process to mute an output of a vehicle-side usual sound via the in-vehicle sound output device 42. It is noted that “muting an output” signifies the reduction of the sound volume or stopping of output of the vehicle-side usual sound.

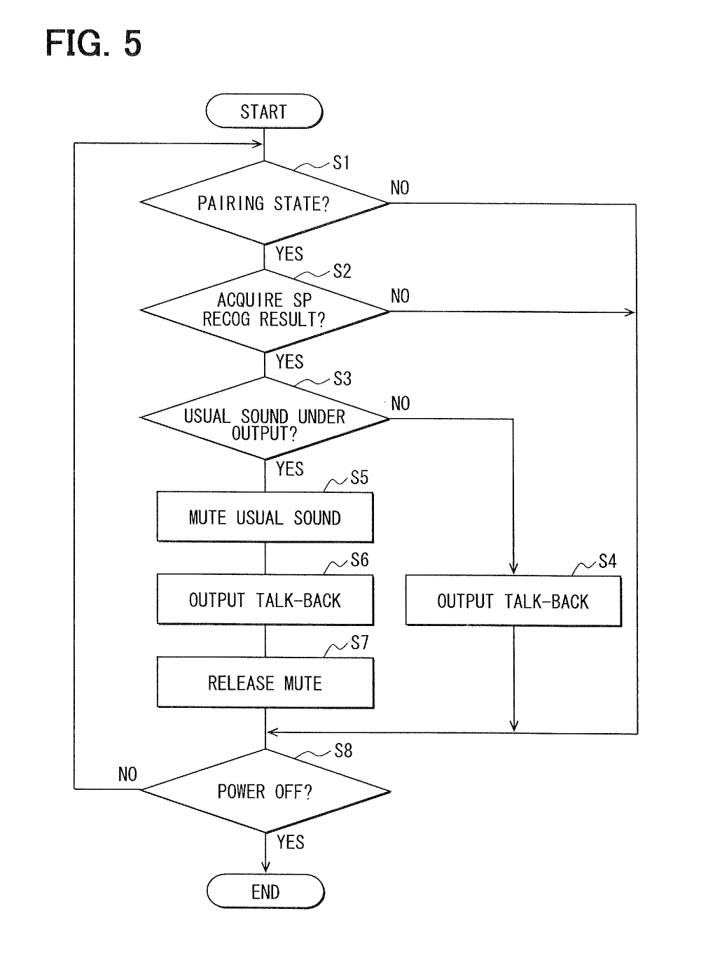

The following will explain a flowchart of a process pertinent to an output of a talk-back speech by the in-vehicle navigation apparatus 3 acting as proxy for the cellular phone 1. FIG. 5 is a flowchart diagram illustrating a process pertinent to an output of a talk-back speech by the in-vehicle navigation apparatus 3 acting as proxy for the cellular phone 1. The present flowchart is started, for instance, when an ignition switch and accessory switch of the subject vehicle are turned on and the power source of the in-vehicle navigation apparatus 3 is turned on.

It is further noted that a flowchart or the processing of the flowchart in the present application includes sections (also referred to as steps), which are represented, for instance, as S1. Further, each section can be divided into several sub-sections while several sections can be combined into a single section. Furthermore, each of thus configured sections can be referred to as a means or unit and achieved not only as a software device but also as a hardware device.

At S1, the navigation control circuit 45 determines whether the in-vehicle navigation apparatus 3 and the cellular phone 1 are paired with each other (i.e. whether the communications pairing state between the in-vehicle navigation apparatus 3 and the cellular phone 1 is established). Whether the in-vehicle navigation apparatus 3 and the cellular phone 1 are paired with each other is determined based on whether the pairing process is executed by the navigation control circuit 45. When it is determined that they are under the paired state (S1: Yes), the processing moves to S2. When it is determined that they are not under the paired state (S1: No), the processing moves to S8.

At S2, the navigation control circuit 45 determines whether the speech recognition result is acquired from the cellular phone 1. Whether the speech recognition result is acquired from the cellular phone 1 may be determined based on whether the speech recognition result received from the cellular phone 1 is inputted into the navigation control circuit 45 from the in-vehicle BT communications device 44. When it is determined that the speech recognition result is acquired (S2: Yes), the processing moves to S3. When it is determined that the speech recognition result is not acquired (S2: No), the processing moves to S8.

At S3, the navigation control circuit 45 determines whether a vehicle-side usual sound is under output via the in-vehicle sound output device 42. Thus, the navigation control circuit 45 may be referred to as an output determination section or means. Whether a vehicle-side usual sound is under output via the in-vehicle sound output device 42 may be determined based on whether the vehicle-side usual sound output process is under execution by the navigation control circuit 45. When it is determined that the vehicle-side usual sound is under output (S3: Yes) the processing moves to S5. When it is determined that the vehicle-side usual sound is not under output (S3: No), the processing moves to S4.

At S4, the navigation control circuit 45 executes the above-mentioned talk-back speech output process, and outputs the talk-back speech about the speech recognition result, which was acquired from the cellular phone 1, via the in-vehicle sound output device 42. The processing then moves to S8.

At S5, the navigation control circuit 45 executes the above-mentioned mute process, and mutes the output of the vehicle-side usual sound in the in-vehicle device side via the in-vehicle sound output device 42. The processing then moves to S6. At S6, the navigation control circuit 45 executes the above-mentioned talk-back speech output process, and outputs the talk-back speech about the speech recognition result, which was acquired from the cellular phone 1, via the in-vehicle sound output device 42. The processing then moves to S7. That is, the in-vehicle navigation apparatus 3 performs a talk-back speech output process as proxy for the cellular phone 1. After the output of the talk-back speech is completed, at S7, the navigation control circuit 45 releases the mute of the vehicle-side usual sound output. The processing then moves to S8.

At S8, when the power source of the in-vehicle navigation apparatus 3 is turned off (S8: Yes), the present process is ended. In addition, when the power source of the in-vehicle navigation apparatus 3 is not turned off (S8: No), the processing returns to S1 and repeats the above sections or steps.

The above configuration enables the following. The in-vehicle navigation apparatus 3 acquires the speech recognition result, which the cellular phone 1 obtained from the speech recognition server 2, via the BT communications link. The in-vehicle navigation apparatus 3 outputs the talk-back speech based on the speech recognition result via the in-vehicle sound output device 42. Even if the cellular phone 1 is incapable of a talk-back speech output, the in-vehicle navigation apparatus 3 can thereby output the talk-back speech resulting from the speech recognition as proxy for the cellular phone 1. In addition, the talk-back speech is outputted via the in-vehicle navigation apparatus 3, enabling the driver even driving the subject vehicle to more easily confirm the speech recognition result. As a result, under the above configuration the driver driving the subject vehicle can confirm more easily the speech recognition result with respect to the cellular phone 1 which does not output the talk-back speech about the speech recognition result.

In the above configuration, when outputting the talk-back speech via the in-vehicle sound output device 42, a vehicle-side usual sound may be presently under output. In such a case, after the output of the vehicle-side usual sound in the in-vehicle navigation apparatus 3 is muted, the talk-back speech is then outputted enabling the talk-back speech to be outputted without overlapping with the vehicle-side usual sound.

Further, the output of the talk-back speech executed by the in-vehicle navigation apparatus 3 as proxy for the cellular phone 1 may be enabled only in the case where the subject vehicle is under travel or running. That is, when the subject vehicle is stopping, the speech recognition result may be displayed in the display device 12 of the cellular phone 1, but the talk-back speech corresponding to the speech recognition result may not be outputted via the in-vehicle sound output device 42 of the in-vehicle navigation apparatus 3. In addition, in this case, whether the subject vehicle is under travel may be determined by the navigation control circuit 45 based on the speed of the subject vehicle detected by the wheel velocity sensor 34. Further, when the vehicle velocity becomes small down to the degree of the velocity disabling the detection by the wheel velocity sensor 34 (e.g., substantively 0 km/h), it may be determined that the subject vehicle is not under travel.

Further, the following configuration may be desirable. When the subject vehicle is under travel, the display indicating the speech recognition result may not be made in the display device 12 of the cellular phone 1, but the output of the talk-back speech corresponding to the speech recognition result may be made via the in-vehicle sound output device 42 of the in-vehicle navigation apparatus 3. In addition, in this case, the determination result as to whether the subject vehicle is under travel may be transmitted to the cellular phone 1 via the BT communications devices 44, 15. When the subject vehicle is under travel, the display indicating the speech recognition result may not be made in the display device 12 in the cellular phone 1. The velocity of the subject vehicle detected by the wheel velocity sensor 34 may be transmitted to the phone control circuit 17 of the cellular phone 1 via the BT communications devices 44, 15. Whether the subject vehicle is under travel may be determined by the phone control circuit 17 of the cellular phone 1.

Furthermore, the cellular phone 1 may have a function to output a sound that is usual in the cellular phone (referred to as a cellular-side usual sound) other than the talk-back speech. The cellular-side usual sound includes a guide sound or speech for sightseeing spots or navigation. In such a case, the navigation control circuit 45 may acquire the sound signal of the cellular-side usual sound using the BT communications link via the BT communications devices 15, 44, outputting the cellular-side usual sound via the in-vehicle sound output device 42. The in-vehicle BT communications device 44 may be referred to as a sound signal acquisition device or means.

Under the above configuration, not only the talk-back speech but also cellular-side usual sound can be outputted via the in-vehicle sound output device 42 of the in-vehicle navigation apparatus 3. This can prevent an inharmonic state where the talk-back speech indicating the speech recognition result is outputted from the in-vehicle navigation apparatus 3, whereas the cellular-side usual sound is outputted from the cellular phone 1.

In addition, when an interrupt by a usual sound output process arises during the output of the talk-back speech via the in-vehicle sound output device 42, the navigation control circuit 45 may arbitrate an output of each sound based on the priority order for each of kinds of sounds. The following will explain an embodiment of the above configuration with reference to drawing. To simplify the explanation of the present modification, an element or component having the same function as that of the element or component explained in the foregoing embodiment is assigned with the same reference number as that in the foregoing embodiment and omitted from the following explanation.

In the present embodiment, a nonvolatile memory such as the external memory 43 of the in-vehicle navigation apparatus 3 or ROM of the navigation control circuit 45 previously stores priority information on the priority order with respect to each of kinds of sounds outputted via the in-vehicle sound output device 42. Therefore, the nonvolatile memory such as the external memory 43 or ROM of the navigation control circuit 45 may be referred to as a priority information storage device or means. The priority information may be a priority table that associates the kinds of sounds with the priority orders, for instance. In addition, the following will be explained on the premise that the priority table is stored in the external memory 43.

The following is an example of the priority table where out of the vehicle-side usual sounds, a guide sound for navigation etc. is associated with a priority order lower than the talk-back speech, whereas a warning sound is associated with a priority order higher than the talk-back speech.

The above mentioned guide sound is exemplified by the guide sound for navigation. There is no need to be limited thereto. For instance, the guide sound may be defined as a sound having a low priority in urgency. When the in-vehicle navigation apparatus 3 has a function to assist parking operation, a guide sound for assisting the parking operation may be included in the above mentioned guide sound. In addition, the warning sound may be defined as a sound having a high priority in urgency. When the in-vehicle navigation apparatus 3 has a function to predict a collision, a warning sound for warning a collision with a pedestrian or other vehicle may be included in the above mentioned warning sound. Further, there may be a case where the in-vehicle navigation apparatus 3 receives a report of an accident vehicle, etc. ahead of the subject vehicle via road-to-vehicle communications with a over-road device, and outputs a warning sound based on the received report. In such a case, such a warning sound may be included in the above mentioned warning sound.

The navigation control circuit 45 refers to the priority table stored in the external memory 43 and performs a priority determination process to determine whether the sound to be outputted via the in-vehicle sound output device 42 is higher or lower in the priority order than the talk-back speech, based on the kind of a sound to be outputted via the in-vehicle sound output device 42 in a usual sound output process. For example, when the kind of the sound to be outputted via the in-vehicle sound output device 42 is a warning sound, the navigation control circuit 45 determines that it is higher in the priority order than the talk-back speech; when the kind of the sound to be outputted via the in-vehicle sound output device 42 is a guide sound, the navigation control circuit 45 determines that it is lower in the priority order than the talk-back speech.

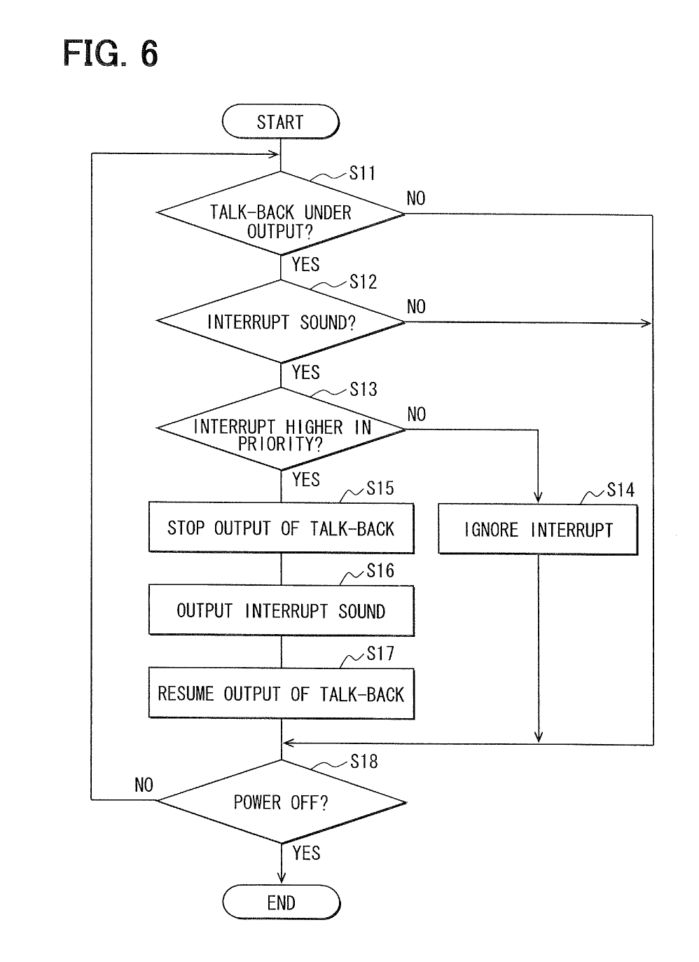

The following will explain an arbitration process with reference to FIG. 6. In the arbitration process when an interrupt by a usual sound output process arises during the talk-back speech output process via the in-vehicle sound output device 42, the output of the talk-back speech and the output of the usual sound are arbitrated. FIG. 6 is a flowchart diagram illustrating such an arbitration process. The present flowchart is started, for instance, when an ignition switch and accessory switch of the subject vehicle are turned on and the power source of the in-vehicle navigation apparatus 3 is turned on.

At S11 the navigation control circuit 45 determines whether a talk-back speech is under output via the in-vehicle sound output device 42. Whether a talk-back speech is under output via the in-vehicle sound output device 42 may be determined based on whether the talk-back speech output process is under execution by the navigation control circuit 45. When it is determined that the talk-back speech is under output (S11: Yes), the processing moves to S12. In contrast, when it is not determined that the talk-back speech is under output (S11: No), the processing moves to S18.

At S12, the navigation control circuit 45 determines whether an interrupt by a usual sound output arises. Whether an interrupt by a usual sound output arises may be determined based on whether the usual sound output process is going to start. When it is determined that an interrupt by a usual sound output arises (S12: Yes) the processing moves to S13. When it is not determined that an interrupt by a usual sound output arises (S12: No), the processing moves to S18.

At S13, the navigation control circuit 45 executes a priority determination process. When it is determined that the sound (i.e., an interrupt sound) to be outputted via the in-vehicle sound output device 42 in the usual sound output process is higher in the priority order than the talk-back speech (S13: Yes), the processing moves to S15. When it is determined that the sound (i.e., an interrupt sound) to be outputted via the in-vehicle sound output device 42 in the usual sound output process is lower in the priority order than the talk-back speech (S13: No), the processing moves to S14.

At S14, the interrupt by the usual sound output process is ignored, the processing moves to S18. In detail, the navigation control circuit 45 continues the talk-back speech output process without executing the usual sound output process.

In addition, at S15, the navigation control circuit 45 suspends the talk-back speech output process so as to suspend the output of the talk-back speech via the in-vehicle sound output device 42. The processing then moves to S16. At S16, the navigation control circuit 45 executes the usual sound output process so as to cause the in-vehicle sound output device 42 to output a vehicle-side usual sound (interrupt sound). The processing then moves to S17. After completing the usual sound output, at S17, the navigation control circuit 45 resumes the talk-back speech output process so as to resume the output of the talk-back speech via the in-vehicle sound output device 42. The processing then moves to S18. When the navigation control circuit 45 resumes the output of the talk-back speech, it is desirable to read out from the start again the talk-back speech of which read-aloud is interrupted.

At S18, when the power source of the in-vehicle navigation apparatus 3 is turned off (S18: Yes), the present process is ended. In addition, when the power source of the in-vehicle navigation apparatus 3 is not turned off (S18: No), the processing returns to S11 and repeat the above sections or steps.

The above configuration enables the sound having urgency such as a warning sound to be outputted in priority to the talk-back speech, raising convenience more.

In the foregoing embodiment, the in-vehicle navigation apparatus 3 is provided to output a talk-back speech about a speech recognition result as proxy for the cellular phone 1. There is no need to be limited to the above. For example, when the cellular phone 1 is provided with a function to execute a display which informs a user of a position of an emergency vehicle or a disabled person, the in-vehicle navigation apparatus 3 may be provided to execute a sound output of information corresponding to the display as proxy for the cellular phone 1.

For example, when the cellular phone 1 generates text data of a guide or warning indicating a position of an emergency vehicle or a disabled person, the navigation control circuit 45 may be provided to acquire the text data using the BT communications link via the BT communications devices 15, 44. The navigation control circuit 45 then executes a known speech synthesis based on the acquired text data and generates a sound signal. The generated sound signal may be transmitted to the in-vehicle sound output device 42, enabling an output of the sound signal, thereby notifying a user of the position of an emergence vehicle or disabled person. It is noted that the above text data may be also referred to as a display related data.

In addition, when the cellular phone 1 acquires position information indicating a position of an emergency vehicles or disabled person with the subject vehicle, the navigation control circuit 45 may be provided to acquire the position information using the BT communications link via the BT communications devices 15, 44. In such a case, the in-vehicle navigation apparatus 3 may be provided to store in a nonvolatile memory such as the external memory 43 an association table, which associates the position information indicating a relative position of an emergency vehicle or disabled person to the subject vehicle with a sound signal of a guide or warning according to the position. Further, the navigation control circuit 45 may be provided to refer to the above-mentioned association table based on the position information, acquire a sound signal associated with the position information, and transmit the sound signal to the in-vehicle sound output device 42, enabling an output of a sound based on the sound signal. The user is thus informed of the position of the emergency vehicle or disabled person. It is noted that the above position information may be also referred to as a display related data.

In the above the function to inform a user using a display is exemplified by the case where a position of an emergency vehicle or disabled person is informed. There is no need to be limited to the above. Further, information that is displayed according to another function of the cellular phone 1 may be also outputted using a sound by the in-vehicle navigation apparatus 3 as proxy for the cellular phone 1.

In the foregoing embodiment, the communications between the cellular phone 1 and the in-vehicle navigation apparatus 3 uses the Bluetooth communications. There is no need to be limited to the above. For example, another wireless communications such as infrared ray communications may be used. Further, the communications between the cellular phone 1 and the in-vehicle navigation apparatus 3 may use wired communications such as using a USB cable.

Further, in the foregoing embodiment, the cellular phone 1 is explained as an example of a portable terminal. There is no need to be limited to the above. Such a portable terminal according to an embodiment of the present invention may be any portable terminal that has a data communications function such as a PDA (Personal Digital Assistant), and DAP (Digital Audio Player).

In the foregoing embodiment, the in-vehicle navigation apparatus 3 is explained as an example of an in-vehicle apparatus according to an embodiment of the present invention. There is no need to be limited to the above. Such an in-vehicle apparatus may be any in-vehicle apparatus that has a sound output device such as a car audio apparatus. When the car audio apparatus is used as the in-vehicle apparatus, an audio sound may be referred to as a vehicle-side usual sound.

Each or any combination of processes, functions, sections, steps, or means explained in the above can be achieved as a software section or unit (e.g., subroutine) and/or a hardware section or unit (e.g., circuit or integrated circuit), including or not including a function of a related device; furthermore, the hardware section or unit can be constructed inside of a microcomputer.

Furthermore the software section or unit or any combinations of multiple software sections or units can be included in a software program, which can be contained in a non-transitory computer-readable storage media or can be downloaded via a communications network and then stored in a non-transitory computer-readable storage media.

Aspects of the disclosure described herein are set out in the following clauses.

As an aspect of the disclosure, an information presentation system including an in-vehicle apparatus in a vehicle and a portable terminal that performs data communications with the in-vehicle apparatus is provided as follows. The portable terminal performs a display based on display related information according to a function of the portable terminal itself. The in-vehicle apparatus includes a sound output device which outputs a sound, a data acquisition device which acquires the display related information from the portable terminal through the data communications, and an output control section configured to cause the sound output device to output a sound according to the function of the portable terminal, based on the display related information according to the function of the portable terminal acquired by the data acquisition device.

As an optional aspect of the disclosure, the information presentation system may include a speech recognition server which has a dictionary for speech recognition. The portable terminal may include a sound input device which receives an input of a speech command from a user, and a display device which displays information. The portable terminal may transmit to the speech recognition server, speech data of the speech command of which the input is received by the sound input device. The portable terminal may perform in the display device a display according to a speech recognition result that is obtained in the speech recognition server by performing a speech recognition based on the speech data using the dictionary. The data acquisition device of the in-vehicle apparatus may acquire the speech recognition result from the portable terminal as the display related information through the data communications. The output control section of the in-vehicle apparatus device may cause the sound output device to output a talk-back speech according to the speech recognition result based on the display related information acquired by the data acquisition device.

Even if the portable terminal is incapable of a talk-back speech output, the in-vehicle apparatus can thereby output the talk-back speech resulting from the speech recognition as proxy for the portable terminal. In addition, the talk-back speech is thus outputted from the in-vehicle apparatus. The speech recognition result can be confirmed more easily by the driver even during driving of the vehicle.

Further, in the just above information presentation system, the speech recognition server may execute the speech recognition based on the speech data, and obtain at least text data as the speech recognition result. The output control section of the in-vehicle apparatus may execute a speech synthesis according to the text data as the speech recognition result acquired by the data acquisition device to obtain a synthesized speech, and cause the sound output device to output as a talk-back speech the synthesized speech obtained by executing the speech synthesis.

Further, in the above information presentation system, the speech recognition server may execute the speech recognition based on the speech data, and obtain at least phoneme data as the speech recognition result. The output control section of the in-vehicle apparatus may execute a speech synthesis according to the phoneme data as the speech recognition result acquired by the data acquisition device to obtain a synthesized speech, and cause the sound output device to output as a talk-back speech the synthesized speech obtained by executing the speech synthesis.

Further, in the above information presentation system, the sound output device of the in-vehicle apparatus may output an in-vehicle apparatus-side usual sound, which is other than the talk-back speech and is according to a function of the in-vehicle apparatus. The in-vehicle apparatus may include an output determination section configured to determine whether the in-vehicle apparatus-side sound is under output via the sound output device of the in-vehicle apparatus. Herein, in case that the output determination section determines that the in-vehicle apparatus-side sound is under output based on that the output control section outputs the talk-back speech via the sound output device, the output control section of the in-vehicle apparatus may mute an output of the in-vehicle apparatus-side usual sound before causing the sound output device to output the talk-back speech.

Thus, the talk-back speech may be outputted without overlapping with the in-vehicle apparatus-side usual sound.

Further, in the above information presentation system, the sound output device of the in-vehicle apparatus may output an in-vehicle apparatus-side usual sound, which is other than the talk-back speech and is according to a function of the in-vehicle apparatus. The in-vehicle device may include a priority storage device to store a priority order with respect to each of kinds of sounds outputted via the sound output device. The output control section may output a sound, which indicates the speech recognition result and is higher in the priority order than the talk-back speech, in priority to the talk-back speech based on the priority order stored in the priority storage device, even while the talk-back speech is under output via the sound output device.

The above configuration enables the sound having urgency such as a warning sound to be outputted in priority to the talk-back speech, raising convenience more.

Further, in the above information presentation system, the portable terminal may output a portable terminal-side usual sound, which is one of a guide sound and a warning sound according to a function of the portable terminal. The in-vehicle apparatus may include a sound signal acquisition device to acquire a sound signal of the portable terminal-side usual sound through the data communications from the portable terminal. The output control section of the in-vehicle apparatus may cause the sound output device to output the portable terminal-side usual sound based on the sound signal acquired by, the sound signal acquisition device.

This can prevent an inharmonic state where the talk-back speech indicating the speech recognition result is outputted from the in-vehicle apparatus, whereas the portable terminal-side usual sound is outputted from the portable terminal.

It will be obvious to those skilled in the art that various changes may be made in the above-described embodiments of the present invention. However, the scope of the present invention should be determined by the following claims.

What is claimed:

1. An information presentation system including an in-vehicle apparatus in a vehicle and a portable terminal that performs data communications with the in-vehicle apparatus,
the portable terminal performing a display based on display related information according to a function of the portable terminal itself,
the in-vehicle apparatus comprising
a sound output device which outputs a sound,
a data acquisition device which acquires the display related information from the portable terminal through the data communications, and
an output control section configured to cause the sound output device to output a sound according to the function of the portable terminal, based on the display related information according to the function of the portable terminal acquired by the data acquisition device.

2. The information presentation system according to claim 1, further comprising:
a speech recognition server which has a dictionary for speech recognition,
the portable terminal comprising
a sound input device which receives an input of a speech command from a user, and
a display device which displays information,
the portable terminal transmitting to the speech recognition server speech data of the speech command of which the input is received by the sound input device,
the portable terminal performing in the display device a display according to a speech recognition result that is obtained in the speech recognition server by performing a speech recognition based on the speech data using the dictionary,
the data acquisition device of the in-vehicle apparatus acquiring the speech recognition result from the portable terminal as the display related information through the data communications,
the output control section of the in-vehicle apparatus device causing the sound output device to output a talk-back speech according to, the speech recognition result based on the display related information acquired by the data acquisition device.

3. The information presentation system according to claim 2,
the speech recognition server
executing the speech recognition based on the speech data, and
obtaining at least text data as the speech recognition result,
the output control section of the in-vehicle apparatus
executing a speech synthesis according to the text data as the speech recognition result acquired by the data acquisition device to obtain a synthesized speech, and
causes the sound output device to output as a talk-back speech the synthesized speech obtained by executing the speech synthesis.

4. The information presentation system according to claim 2,
the speech recognition server
executing the speech recognition based on the speech data, and
obtaining at least phoneme data as the speech recognition result,
the output control section of the in-vehicle apparatus
executing a speech synthesis according to the phoneme data as the speech recognition result acquired by the data acquisition device to obtain a synthesized speech, and
causing the sound output device to output as a talk-back speech the synthesized speech obtained by executing the speech synthesis.

5. The information presentation system according to claim 2,
the sound output device of the in-vehicle apparatus outputting an in-vehicle apparatus-side usual sound, which is other than the talk-back speech and is according to a function of the in-vehicle apparatus,
the in-vehicle apparatus comprising an output determination section configured to determine whether the in-vehicle apparatus-side sound is under output via the sound output device of the in-vehicle apparatus,
wherein
in case that the output determination section determines that the in-vehicle apparatus-side sound is under output when the output control section outputs the talk-back speech via the sound output device,
the output control section of the in-vehicle apparatus mutes an output of the in-vehicle apparatus-side usual sound before causing the sound output device to output the talk-back speech.

6. The information presentation system according to claim 2,
the sound output device of the in-vehicle apparatus outputting an in-vehicle apparatus-side usual sound, which is other than the talk-back speech and is according to a function of the in-vehicle apparatus,
the in-vehicle device comprising a priority storage device to store a priority order with respect to each of kinds of sounds outputted via the sound output device,
the output control section outputting a sound, which indicates the speech recognition result and is higher in the priority order than the talk-back speech, in priority to the talk-back speech based on the priority order stored in the priority storage device, even while the talk-back speech is under output via the sound output device.

7. The information presentation system according to claim 2,
the portable terminal outputting a portable terminal-side usual sound, which is one of a guide sound and a warning sound according to a function of the portable terminal,
the in-vehicle apparatus comprising a sound signal acquisition device to acquire a sound signal of the portable terminal-side usual sound through the data communications from the portable terminal,
the output control section of the in-vehicle apparatus causing the sound output device to output the portable terminal-side usual sound based on the sound signal acquired by the sound signal acquisition device.
